(19) United States
(12) Patent Application Publication
(10) Pub. No.: US 2024/0264024 A1
(43) Pub. Date: Aug. 8, 2024

(54) FLUIDIC DEVICE AND MANUFACTURING METHOD OF FLUIDIC DEVICE

(71) Applicant: Surpass Industry Co., Ltd., Saitama (JP)

(72) Inventor: Hiroshi IMAI, Saitama (JP)

(21) Appl. No.: 18/431,577

(22) Filed: Feb. 2, 2024

(30) Foreign Application Priority Data
Feb. 8, 2023 (JP) 2023-017626

(51) Int. Cl. G01L 19/14; G01L 19/00

(52) U.S. Cl. CPC G01L 19/14; G01L 19/0007

(57) ABSTRACT

Provided is a pressure detection device including a pressure sensor, a resin flow path body, a sensor holder that presses and fixes the pressure sensor against and to the accommodation part of the flow path body along the axis, and an O-ring being in contact with the pressure sensor to form an annular seal area. The accommodation part has an inner circumferential face formed in a cylindrical shape, an opening hole communicating with a flow path, and a bottom face, the sensor holder has a tapping screw formed on an outer circumferential face formed in a cylindrical shape, and the tapping screw is fastened into the inner circumferential face to fix the pressure sensor to the accommodation part.

### CROSS-REFERENCE TO RELATED APPLICATIONS

This application claims foreign priority benefits under U.S.C. § 119 to Japanese Patent Application No. 2023-017626 filed on Feb. 8, 2023, the contents of which is hereby incorporated by reference in its entirety.

### BACKGROUND

### 1. Technical Field

The present disclosure relates to a fluidic device and a manufacturing method of a fluidic device.

### 2. Description of Related Art

Conventionally, a pressure detection device including a flow path unit inside which a flow path to guide a fluid to a pressure detection surface of a pressure sensor is formed is known (for example, see Japanese Patent Application Laid-Open No. 2017-227525). In the pressure detection device disclosed in Japanese Patent Application Laid-Open No. 2017-227525, the pressure sensor is arranged in a recess of the flow path unit, an external thread formed on the outer circumferential face of an outer holder formed in a cylindrical shape is fastened to an internal thread formed in the inner circumferential face of the recess of the flow path unit, and thereby the pressure sensor is held at a certain position relative to the flow path unit. An O-ring arranged in a bottom face portion of the recess of the flow path unit comes into contact with the pressure sensor to form a seal area, and inflow of a fluid from the flow path to the pressure sensor side is prevented by the seal area.

However, since backlash is present between the external thread of the outer holder and the internal thread of the recess of the flow path unit, the pressure detection surface may separate from the O-ring for the amount of backlash when the pressure of the fluid inside the flow path instantaneously rises causing a rise in the pressure applied to the pressure detection surface, for example. In such a case, at least a part of the seal area will disappear, and the fluid will flow into the pressure sensor side from a gap between the pressure detection surface and the O-ring.

### BRIEF SUMMARY

The present disclosure has been made in view of such circumstances and intends to provide a fluidic device that can prevent a liquid from flowing into the liquid contact part side from a flow path even when an event of an instantaneous rise in the liquid pressure inside the flow path occurs and also provide a manufacturing method of the fluidic device.

The present disclosure employs the following solutions to achieve the above object.

The fluidic device according to the first aspect of the present disclosure includes: a liquid contact part including a contact surface to be in contact with a liquid; a resin flow path part including a flow path and an accommodation part, the flow path extending along an axis and being configured to guide a liquid to the contact surface, and the accommodation part accommodating the liquid contact part; a fixing part configured to press the liquid contact part against the accommodation part along the axis to fix a position along the axis of the liquid contact part; and a seal part forming an annular seal area configured to prevent inflow of a liquid to an outer circumferential side of a contact area where the liquid contact part and the accommodation part are in contact with each other. The accommodation part has an inner circumferential face formed cylindrically about the axis, an opening hole communicating with the flow path, and a bottom face formed annularly about the axis so as to surround the opening hole, the liquid contact part being in contact with the bottom face. The fixing part has an outer circumferential face formed cylindrically about the axis and a tapping screw formed on the outer circumferential face. The fixing part fastens the tapping screw into the inner circumferential face to fix the liquid contact part to the accommodation part.

According to the fluidic device of the first aspect of the present disclosure, the liquid contact part accommodated in the accommodation part of the flow path part is pressed against the accommodation part along the axis by the fixing part, and thereby the position of the liquid contact part along the axis is fixed. Inflow of a liquid to the outer circumferential side of the contact area where the liquid contact part pressed against the accommodation part by the fixing part and the contact part are in contact with each other is prevented by the annular seal area formed by the seal part. The fixing part fastens the tapping screw into the inner circumferential face of the resin accommodation part to fix the liquid contact part to the accommodation part. The tapping screw has been fastened into the inner circumferential face of the resin accommodation part, and no backlash is present in a portion where the tapping screw and the inner circumferential face are fastened to each other. Thus, even when an event of an instantaneous rise in the pressure of a fluid inside the flow path occurs, the seal area formed by the liquid contact part and the seal part is maintained over the entire circumference, and this makes it possible to prevent the liquid from flowing into the liquid contact part side from the flow path.

The fluidic device according to the second aspect of the present disclosure is further configured as follows in the first aspect. That is, at least one groove formed annularly about the axis is formed in a region of the inner circumferential face of the accommodation part, the tapping screw being fastened to the region.

According to the fluidic device of the second aspect of the present disclosure, since the groove is formed in the inner circumferential face of the accommodation part, deformation of the accommodation part that would occur when the tapping screw is fastened can be suitably absorbed by the groove.

The fluidic device according to the third aspect of the present disclosure is further configured as follows in the second aspect. That is, the inner diameter of the groove is larger than the nominal diameter of the tapping screw.

According to the fluidic device of the third aspect of the present disclosure, since the inner diameter of the groove is larger than the nominal diameter of the tapping screw, the bottom face of the groove is arranged outside the outermost point of the tapping screw with respect to the axis, and deformation of the accommodation part can be reliably absorbed by the groove.

The fluidic device according to the fourth aspect of the present disclosure is further configured as follows in the third aspect. That is, in the inner circumferential face of the accommodation part, a plurality of grooves are formed spaced apart from each other in a direction along the axis.

According to the fluidic device of the fourth aspect of the present disclosure, since a plurality of grooves are formed spaced by a distance from each other in the direction along the axis, deformation of the accommodation part can be reliably absorbed by the plurality of grooves.

The fluidic device according to the fifth aspect of the present disclosure is further configured as follows in the fourth aspect. That is, the distance between a pair of the grooves adjacent to each other in a direction along the axis is longer than the pitch of the tapping screw.

According to the fluidic device of the fifth aspect of the present disclosure, since the distance between a pair of grooves adjacent to each other in the direction along the axis is longer than the pitch of the tapping screw, it is possible to prevent the fastening force applied between the tapping screw and the accommodation part from decreasing due to an excessively short distance between the pair of grooves.

The fluidic device according to the sixth aspect of the present disclosure is further configured as follows in any one of the first aspect to the fifth aspect. That is, an annular groove which is formed annularly about the axis and in which the seal part is secured is formed in the bottom face of the accommodation part, the seal part is formed annularly of an elastic material and secured in the annular groove, and the seal area is formed by contact of the seal part with the liquid contact part.

According to the fluidic device of the sixth aspect of the present disclosure, the seal part formed annularly of an elastic material is secured in the annular groove formed in the bottom face of the accommodation part, and thereby the liquid contact part, which is pressed against the accommodation part, and the seal part can be in contact with each other to form an annular seal area.

The fluidic device according to the seventh aspect of the present disclosure is further configured as follows in any one of the first aspect to the fifth aspect. That is, the liquid contact part has a pressure detection surface configured to detect a pressure of a liquid, and a protective film arranged in contact with the pressure detection surface and configured to block contact between the pressure detection surface and a liquid, the protective film and the bottom face are formed of a resin material, and the protective film is arranged so as to close the opening hole of the accommodation part and welded to the bottom face in the seal area extending in a circumferential direction about the axis.

According to the fluidic device of the seventh aspect of the present disclosure, since the protective film arranged in contact with the pressure detection surface of the liquid contact part and the bottom face of the accommodation part are welded together, the annular seal area can be formed on the outer circumferential side of the contact area where the liquid contact part and the bottom face of the accommodation part are in contact with each other. Further, the tapping screw has been fastened into the inner circumferential face of the resin accommodation part, and no backlash is present in a portion where the tapping screw and the inner circumferential face are fastened to each other. Thus, even when an event of an instantaneous rise in the fluid pressure inside the flow path occurs, the state where the pressure detection surface is pressed against the seal area is maintained. Accordingly, it is possible to suitably prevent an event of an instantaneous rise in the liquid pressure inside the flow path from occurring in a state where the pressure detection surface is not pressed against the seal area and prevent a part of the seal area from being damaged causing inflow of the liquid into the contact area.

The fluidic device according to the eighth aspect of the present disclosure is further configured as follows in any one of the first aspect to the fifth aspect. That is, the fixing part is formed of a metal material.

According to the fluidic device of the eighth aspect of the present disclosure, the fixing part is formed of a metal material, and this makes it possible to reliably fasten the tapping screw into the inner circumferential face of the resin accommodation part without deforming the tapping screw.

The fluidic device according to the ninth aspect of the present disclosure is further configured as follows in any one of the first aspect to the fifth aspect. That is, the fixing part is formed of a resin material having higher hardness than the inner circumferential face of the accommodation part.

According to the fluidic device of the ninth aspect of the present disclosure, the fixing part is formed of a resin material having higher hardness than the inner circumferential face of the accommodation part, and this makes it possible to reliably fasten the tapping screw into the inner circumferential face of the accommodation part without deforming the tapping screw.

The fluidic device according to the tenth aspect of the present disclosure is further configured as follows in any one of the first aspect to the fifth aspect. That is, the liquid contact part detects a pressure of a fluid in contact with the contact surface.

According to the fluidic device of the tenth aspect of the present disclosure, even when an event of an instantaneous rise in the pressure of a fluid inside the flow path occurs, the seal area formed by the liquid contact part, which detects a pressure, and the seal part is maintained over the entire circumference, and this makes it possible to prevent the fluid from flowing into the liquid contact part side from the flow path.

The manufacturing method of a fluidic device according to the eleventh aspect of the present disclosure is a manufacturing method of a fluidic device, and the fluidic device includes a liquid contact part including a contact surface to be in contact with a liquid, a resin flow path part including a flow path and an accommodation part, the flow path extending along an axis and being configured to guide a liquid to the contact surface, and the accommodation part accommodating the liquid contact part, a fixing part configured to press the liquid contact part against the accommodation part along the axis to fix a position along the axis of the liquid contact part, and a seal part secured in the accommodation part and forming an annular seal area in contact with the liquid contact part pressed against the accommodation part by the fixing part, the accommodation part has an inner circumferential face formed cylindrically about the axis, an opening hole communicating with the flow path, and a bottom face formed annularly about the axis so as to surround the opening hole, the liquid contact part being in contact with the bottom face, and the fixing part has an outer circumferential face formed cylindrically about the axis and a tapping screw formed on the outer circumferential face. The manufacturing method includes: an installation step of installing the fluid contact part in the accommodation part; and a fixing step of fixing the liquid contact part to the accommodation part by fastening the tapping screw into the inner circumferential face.

According to the manufacturing method of the fluidic device of the eleventh aspect of the present disclosure, the liquid contact part is installed in the accommodation part in the installation step, and the liquid contact part is fixed to the accommodation part by fastening the tapping screw into the inner circumferential face in the fixing step. Inflow of a liquid to the outer circumferential side of the contact area where the liquid contact part pressed against the accommodation part by the fixing part and the contact part are in contact with each other is prevented by the annular seal area formed by the seal part. The tapping screw has been fastened into the inner circumferential face of the resin accommodation part, and no backlash is present in a portion where the tapping screw and the inner circumferential face are fastened to each other. Thus, even when an event of an instantaneous rise in the pressure of a fluid inside the flow path occurs, the seal area formed by the liquid contact part and the seal part is maintained over the entire circumference, and this makes it possible to prevent the liquid from flowing into the liquid contact part side from the flow path.

According to the present disclosure, it is possible to provide a fluidic device that can prevent a liquid from flowing into the liquid contact part side from a flow path even when an event of an instantaneous rise in the pressure of a liquid inside the flow path occurs and also provide a manufacturing method of the fluidic device.

### BRIEF DESCRIPTION OF THE SEVERAL VIEWS OF THE DRAWINGS

FIG. 1 is a longitudinal sectional view illustrating a pressure detection device of a first embodiment of the present disclosure.

FIG. 2 is a partial enlarged view of the pressure detection device illustrated in FIG. 1.

FIG. 3 is an exploded view of the pressure detection device illustrated in FIG. 1.

FIG. 4 is a partial enlarged view of a part A of the pressure detection device illustrated in FIG. 2.

FIG. 5 is a front view of a sensor holder illustrated in FIG. 3.

FIG. 6 is a flowchart illustrating a manufacturing method of the pressure detection device of the first embodiment of the present disclosure.

FIG. 7 is a partial enlarged view of a pressure detection device of a second embodiment of the present disclosure.

FIG. 8 is an exploded view of the pressure detection device of the second embodiment of the present disclosure.

FIG. 9 is an exploded view of a pressure detection device of a modified example of the present disclosure.

### DETAILED DESCRIPTION

### First Embodiment

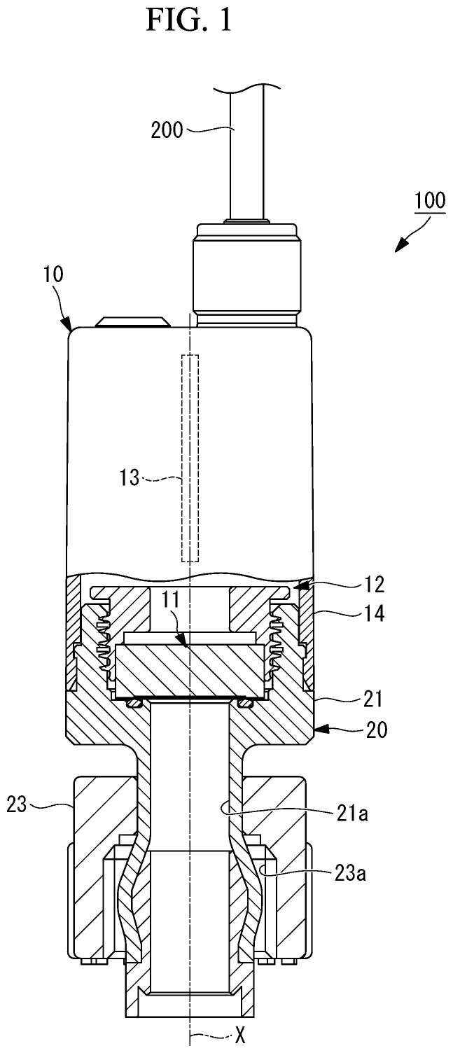

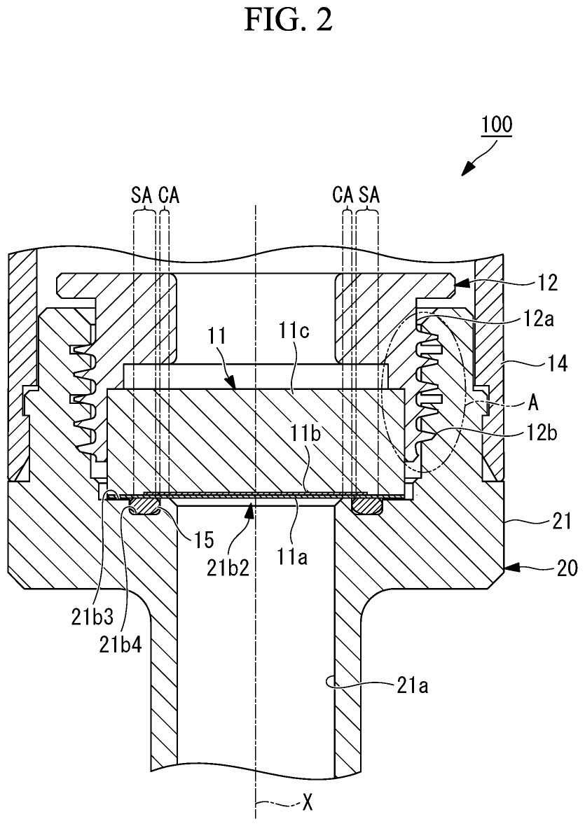

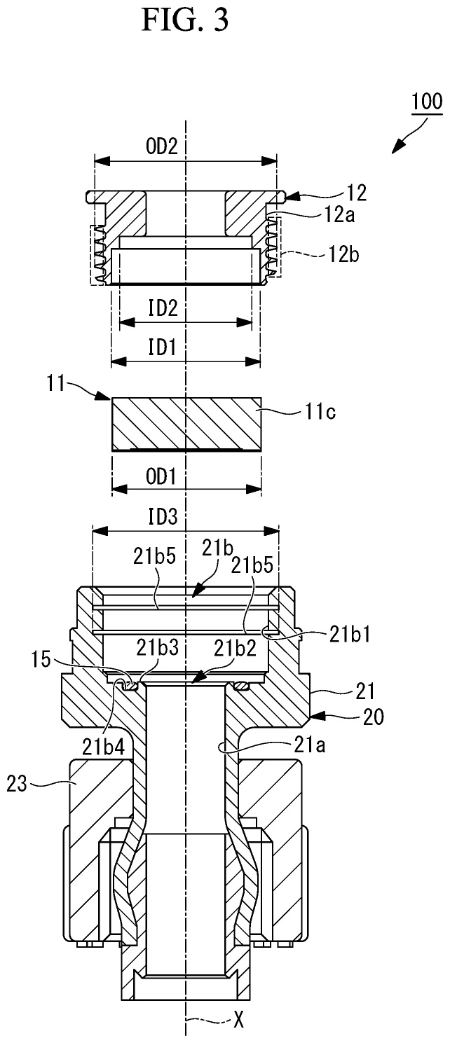

A pressure detection device (fluidic device) 100 of a first embodiment of the present disclosure will be described below with reference to the drawings. FIG. 1 is a longitudinal sectional view illustrating the pressure detection device 100 of the first embodiment of the present disclosure. FIG. 2 is a partial enlarged view of the pressure detection device 100 illustrated in FIG. 1. FIG. 3 is an exploded view of the pressure detection device 100 illustrated in FIG. 1.

As illustrated in FIG. 1 and FIG. 2, the pressure detection device 100 of the present embodiment includes a pressure detection unit 10 used for detecting the pressure of a fluid and a flow path unit 20 including a flow path body 21 inside which a flow path 21a is formed. The flow path 21a is connected to a flow path (not illustrated) branched from a pipe (not illustrated) through which a fluid flows.

The fluid in the present embodiment may be a liquid such as chemicals, solvents, pure water, or the like used in semiconductor manufacturing processes performed by semiconductor manufacturing devices. Further, the fluid in the present embodiment may be a gas such as air, a nitrogen gas, or the like. In semiconductor manufacturing processes, air or a nitrogen gas is used for washing the flow path or discharging a liquid. Note that, when a liquid is discharged, the liquid being discharged and the gas used for discharging the liquid are in a mixed state.

Next, the flow path unit 20 of the pressure detection device 100 of the present embodiment will be described.

As illustrated in FIG. 1 and FIG. 2, the flow path unit 20 includes a flow path body (flow path part) 21 and a nut 23. As illustrated in FIG. 3, the flow path body 21 has the flow path 21a and an accommodation part 21b. The flow path 21a extends along the axis X and guides a fluid to a diaphragm (contact surface) 11a (see FIG. 2) of a pressure sensor 11.

The flow path body 21 is formed of a fluororesin material. The fluororesin material may be, for example, polytetrafluoroethylene (PTFE), polychlorotrifluoroethylene (PCTFE), or tetrafluoroethylene-perfluoroalkylvinylether copolymer (PFA).

The accommodation part 21b is a recess to accommodate the pressure sensor 11. As illustrated in FIG. 3, the accommodation part 21b has an inner circumferential face 21b1 formed cylindrically about the axis X, an opening hole 21b2 communicating with the flow path 21a, and a bottom face 21b3 formed annularly about the axis X so as to surround the opening hole 21b2. In the bottom face 21b3, an annular groove 21b4 which is formed annularly about the axis X and in which an O-ring (seal part) 15 is secured is formed.

The O-ring 15 is a member formed annularly of an elastic material such as a rubber material. The O-ring 15 forms an annular seal area SA that prevents inflow of a liquid to the outer circumferential side (outside with respect to the axis X) of the contact area CA where the diaphragm 11a and the bottom face 21b3 of the accommodation part 21b are in contact with each other. The O-ring 15 is in contact with the diaphragm 11a of the pressure sensor 11 installed in the accommodation part 21b and thereby forms the seal area SA.

The nut 23 is a member that connects the flow path body 21 to a flow path (not illustrated) branched from a pipe (not illustrated) through which a fluid flows. An internal thread 23a formed in the inner circumferential face of the nut 23 is fastened to an external thread (not illustrated) formed on the outer circumferential face of the branched flow path, and thereby the flow path 21a of the flow path body 21 and the branched flow path are connected to each other.

Next, the pressure detection unit 10 of the pressure detection device 100 of the present embodiment will be described. The pressure detection unit 10 is a device that detects the pressure of a fluid transferred to the diaphragm 11a.

As illustrated in FIG. 1 and FIG. 2, the pressure detection unit 10 includes the pressure sensor (liquid contact part) 11 that detects the pressure of a fluid, a sensor holder (fixing part) 12, a sensor substrate 13, a housing 14, and the O-ring 15. Each part of the pressure detection unit 10 will be described below.

As illustrated in FIG. 2, the pressure sensor 11 includes the diaphragm (contact surface) 11a, a strain gage 11b that is a resistor mounted on the diaphragm 11a, and a base part 11c that holds the diaphragm 11a. The pressure sensor 11 is a strain gage type pressure sensor that outputs a pressure signal in accordance with the resistance value of the strain gage 11b that varies in accordance with a pressure transferred to the diaphragm 11a. The diaphragm 11a is a contact surface to be in contact with a liquid and is formed of a nonconductive material (such as sapphire or ceramics, for example) having corrosion resistance and chemical resistance.

The sensor holder 12 is a member made of a metal (for example, stainless such as SUS304) formed circular-cylindrically about the axis X. The sensor holder 12 presses the pressure sensor 11 against the accommodation part 21b of the flow path body 21 along the axis X to fix the position along the axis X of the pressure sensor 11. The sensor holder 12 has an outer circumferential face 12a formed cylindrically about the axis X and a tapping screw 12b that is an external thread formed on the outer circumferential face 12a.

The tapping screw 12b has an angle θ of thread that is smaller than 60 degrees corresponding to the angle of thread close to metric threads (metric coarse threads, metric fine threads). It is desirable that the angle θ be within a range greater than 0 degree and less than or equal to 35 degrees, for example.

As illustrated in FIG. 3, the sensor holder 12 has a stepped shape in which the inner diameter ID1 about the axis X at the lower end is larger than the outer diameter OD1 of the base part 11c of the pressure sensor 11 and the inner diameter ID2 about the axis X at a portion above the lower end is smaller than the outer diameter OD1 of the base part 11c of the pressure sensor 11. The tapping screw 12b formed on the outer circumferential face 12a of the sensor holder 12 is fastened into the inner circumferential face 21b1 of the accommodation part 21b, and thereby the sensor holder 12 fixes the position in the axis X direction of the pressure sensor 11.

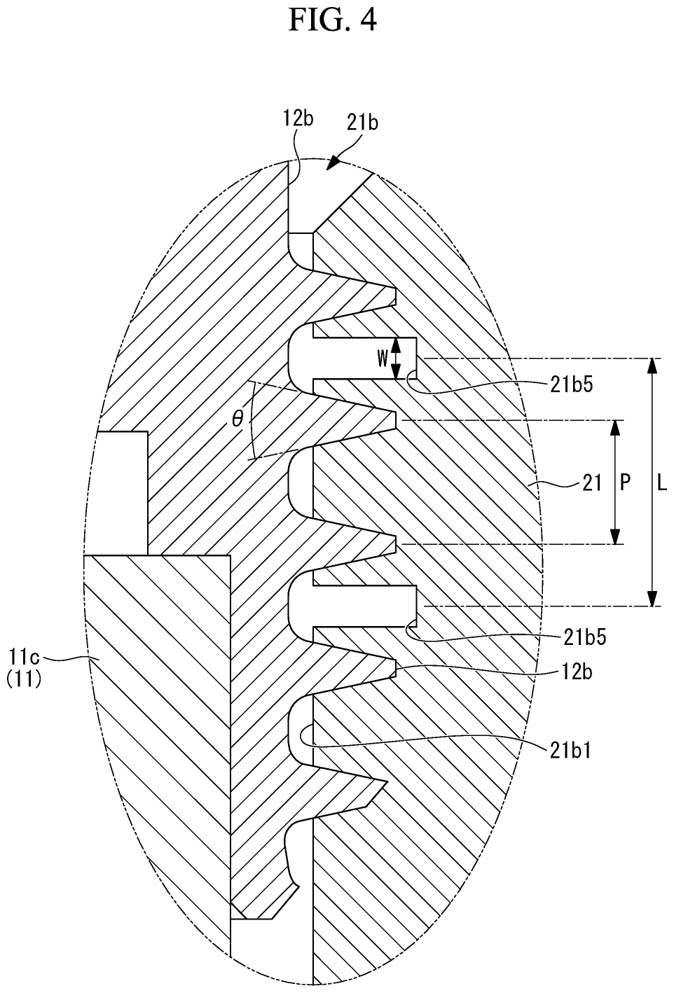

FIG. 4 is a partial enlarged view of the part A of the pressure detection device 100 illustrated in FIG. 2. As illustrated in FIG. 4, grooves 21b5 formed annularly about the axis X are formed in a region of the inner circumferential face 21b1 of the accommodation part 21b into which the tapping screw 12b is fastened. As illustrated in FIG. 3, the inner diameter ID3 of each groove 21b5 is larger than the nominal diameter OD2 of the tapping screw 12b.

As illustrated in FIG. 3 and FIG. 4, two grooves 21b5 are formed spaced apart from each other in a direction along the axis X in the inner circumferential face 21b1 of the accommodation part 21b. Note that, although two grooves 21b5 are formed in the inner circumferential face 21b1 in FIG. 3 and FIG. 4, other forms may be employed. One or three or more grooves 21b5 may be formed spaced apart from each other in the direction along the axis X in the inner circumferential face 21b1 of the accommodation part 21b.

As illustrated in FIG. 4, it is preferable that the distance L between a pair of the grooves 21b5 adjacent to each other in the direction along the axis X be longer than the pitch P of the tapping screw. Further, it is preferable to set the width W in the direction along the axis X of the groove 21b5 so as to satisfy the following equation (1).

$$0.2 \times P \leq W \leq 0.8 \times P \qquad ( 1 )$$

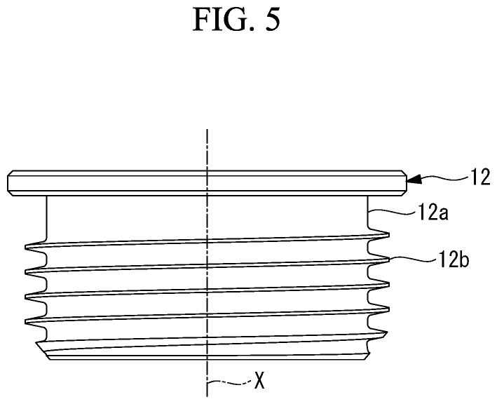

FIG. 5 is a front view of the sensor holder 12 illustrated in FIG. 3. As illustrated in FIG. 5, a single thread of tapping screw 12b is formed on the outer circumferential face 12a of the sensor holder 12. Note that two or more threads of, namely, multiple threads of tapping screw 12b may be formed on the outer circumferential face 12a of the sensor holder 12.

The sensor substrate 13 includes an amplifier circuit (not illustrated) that amplifies a pressure signal output from the pressure sensor 11, an interface circuit that transfers the pressure signal amplified by the amplifier circuit to a pressure signal line (not illustrated) in a cable 200 (see FIG. 1, FIG. 2), and a power supply circuit (not illustrated) that transfers a power supply voltage externally supplied via the cable 200 to the pressure sensor 11.

The housing 14 is a member formed circular-cylindrically about the axis X, and the inner circumferential face on the lower end side thereof is attached to the outer circumferential face on the upper end side of the flow path body 21. The housing 14 accommodates the sensor substrate 13 on the inner circumferential side thereof.

The O-ring 15 is a circular annular elastic member arranged in the annular groove 21b4 formed in the bottom face 21b3 of the accommodation part 21b. The O-ring 15 is in contact with the pressure sensor 11 pressed against the bottom face 21b3 of the accommodation part 21b by the sensor holder 12 and thereby forms a seal area formed annularly about the axis X between the diaphragm 11a and the O-ring 15. The seal area prevents a fluid from flowing into the pressure detection unit 10 side from the flow path 21a.

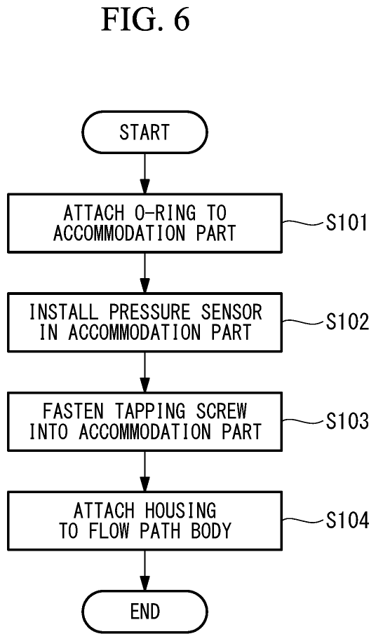

Next, a manufacturing method of the pressure detection device 100 of the present embodiment will be described with reference to FIG. 6. FIG. 6 is a flowchart illustrating the manufacturing method of the pressure detection device 100 of the first embodiment of the present disclosure.

In step S101, the operator attaches the O-ring 15 to the annular groove 21b4 formed in the bottom face 21b3 of the accommodation part 21b of the flow path body 21.

In step S102, the operator installs the pressure sensor 11 in the accommodation part 21b to cause the diaphragm 11a of the pressure sensor 11 to come into contact with the O-ring 15.

In step S103, the operator uses a torque wrench (not illustrated) to rotate the sensor holder 12 about the axis X to fasten the tapping screw 12b into the inner circumferential face 21b1 of the accommodation part 21b. The operator creates the state illustrated in FIG. 4 by rotating the sensor holder 12 about the axis X until the torque set for the torque wrench is reached.

In step S104, the operator attaches the housing 14 to the flow path body 21.

With the above steps, the operator creates a state where the pressure sensor 11 has been accommodated in the accommodation part 21b of the flow path body 21, the tapping screw 12b has been fastened into the inner circumferential face 21b1 of the resin accommodation part 21b, and the diaphragm 11a of the pressure sensor 11 whose position in the axis X direction is fixed by the sensor holder 12 is in contact with the O-ring 15 to form the annular seal area.

The effects and advantages achieved by the pressure detection device 100 of the present embodiment described above will be described.

According to the pressure detection device 100 of the present embodiment, the pressure sensor 11 accommodated in the accommodation part 21b of the flow path body 21 is pressed against the accommodation part 21b along the axis X by the sensor holder 12, and thereby the position of the pressure sensor 11 along the axis X is fixed. The pressure sensor 11 pressed against the accommodation part 21b by the sensor holder 12 and the O-ring 15 are in contact with each other to form an annular seal area.

The tapping screw 12b is fastened into the inner circumferential face 21b1 of the resin accommodation part 21b, and thereby the sensor holder 12 fixes the pressure sensor 11 to the accommodation part 21b. The tapping screw 12b has been fastened into the inner circumferential face 21b1 of the resin accommodation part 21b, and no backlash is present in a portion where the tapping screw 12b and the inner circumferential face 21b1 are fastened to each other. Thus, even when an event of an instantaneous rise in the pressure of a fluid inside the flow path 21a occurs, the seal area formed by the pressure sensor 11 and the O-ring 15 is maintained over the entire circumference, and this makes it possible to prevent the fluid from flowing into the pressure sensor 11 side from the flow path 21a.

Further, according to the pressure detection device 100 of the present embodiment, since the grooves 21b5 are formed in the inner circumferential face 21b1 of the accommodation part 21b, deformation of the accommodation part 21b that would occur when the tapping screw 12b is fastened can be suitably absorbed by the groove 21b5.

Further, according to the pressure detection device 100 of the present embodiment, since the inner diameter ID3 of the groove 21b5 is larger than the nominal diameter OD2 of the tapping screw 12b, the bottom face of the groove 21b5 is arranged outside the outermost point of the tapping screw 12b with respect to the axis X, and deformation of the accommodation part 21b can be reliably absorbed by the groove 21b5.

Further, according to the pressure detection device 100 of the present embodiment, since a plurality of grooves 21b5 are formed spaced by the distance L from each other in the direction along the axis X, deformation of the accommodation part 21b can be reliably absorbed by the plurality of grooves 21b5.

Further, according to the pressure detection device 100 of the present embodiment, since the distance L between a pair of grooves 21b5 adjacent to each other in the direction along the axis X is longer than the pitch P of the tapping screw 12b, it is possible to prevent the fastening force applied between the tapping screw 12b and the accommodation part 21b from decreasing due to an excessively short distance between the pair of grooves 21b5.

Further, according to the pressure detection device 100 of the present embodiment, the O-ring 15 is secured in the annular groove 21b4 formed in the bottom face 21b3 of the accommodation part 21b, and thereby the pressure sensor 11, which is pressed against the accommodation part 21b, and the O-ring 15 can be in contact with each other to form the annular seal area.

Further, according to the pressure detection device 100 of the present embodiment, the sensor holder 12 is formed of a metal material, and this makes it possible to reliably fasten the tapping screw 12b into the inner circumferential face 21b1 of the resin accommodation part 21b without deforming the tapping screw 12b.

Further, according to the pressure detection device 100 of the present embodiment, even when an event of an instantaneous rise in the pressure of a fluid inside the flow path 21a occurs, the seal area formed by the pressure sensor 11, which detects a pressure, and the O-ring 15 is maintained in the entire circumference, and this makes it possible to prevent the fluid from flowing into the pressure sensor 11 side from the flow path 21a.

### Second Embodiment

Next, a pressure detection device 100A of a second embodiment of the present disclosure will be described with reference to the drawings. The present embodiment is a modified example to the first embodiment and, except when particularly described below, is the same as the first embodiment. Thus, some description will be omitted below.

The pressure detection device 100 of the first embodiment is such that the O-ring 15 secured in the annular groove 21b4 formed in the bottom face 21b3 of the accommodation part 21b is caused to be in contact with the diaphragm 11a of the pressure sensor 11 to form the seal area SA on the outer circumferential side of the contact area CA. In contrast, the pressure detection device 100A of the present embodiment is such that a protective film 11d arranged in contact with the diaphragm 11a is welded to the bottom face 21b3 of the accommodation part 21b to form the seal area SA on the outer circumferential side of the contact area CA.

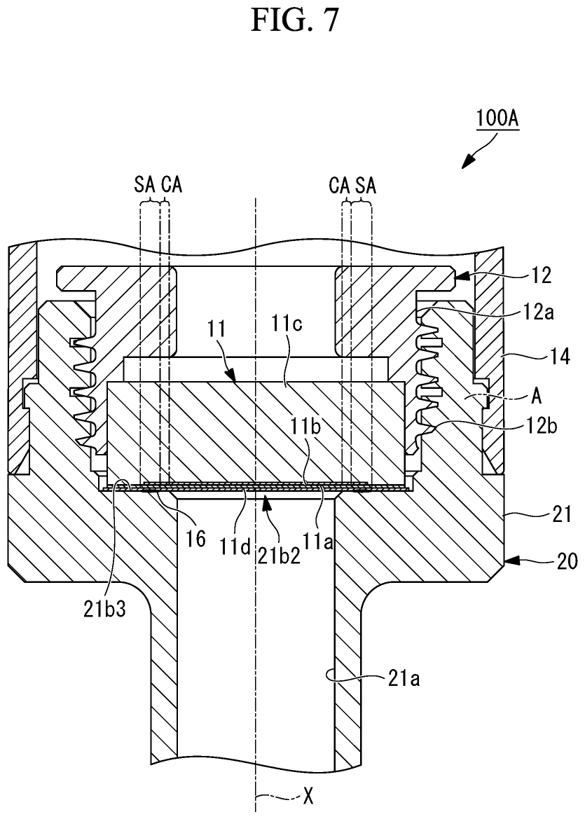

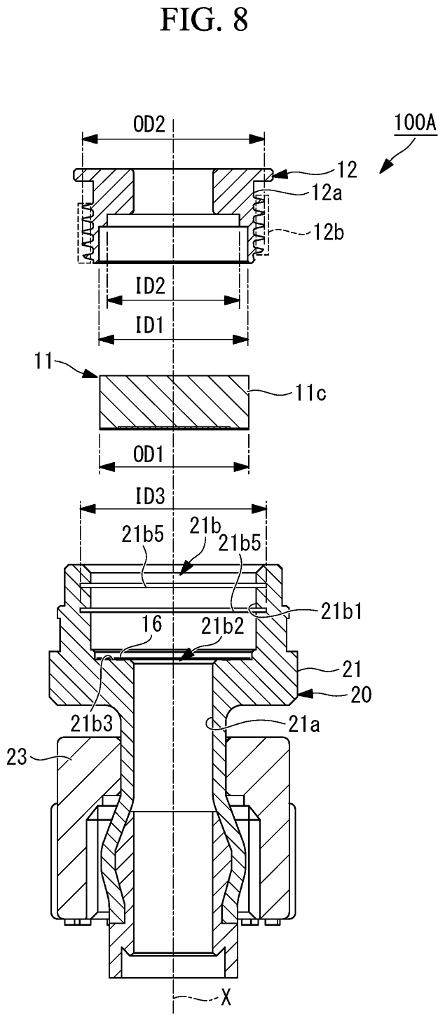

FIG. 7 is a partial enlarged view of the pressure detection device 100A of the second embodiment of the present disclosure. FIG. 8 is an exploded view of the pressure detection device 100A of the second embodiment of the present disclosure. As illustrated in FIG. 7 and FIG. 8, the pressure sensor 11 has a thin-film protective film 11d that is arranged in contact with the diaphragm 11a and blocks contact between the diaphragm 11a and a liquid. The protective film 11d is formed of the same resin material as the accommodation part 21b (for example, perfluoroalkoxy fluororesin (PFA) that is a thermoplastic fluororesin). As illustrated in FIG. 7 and FIG. 8, the protective film 11d is arranged so as to close the opening hole 21b2 of the accommodation part 21b. Further, the protective film 11d is welded to the bottom face 21b3 of the accommodation part 21b in the seal area SA extending in the circumferential direction about the axis X. The welded part (seal part) 16 illustrated in FIG. 7 and FIG. 8 represents a portion where the protective film 11d and the accommodation part 21b formed of the same material are melted into one piece. The welded part 16 is formed by being irradiated with a laser beam (for example, a carbon dioxide laser beam) from above the protective film 11d.

According to the pressure detection device 100A of the present embodiment, since the protective film 11d arranged in contact with the diaphragm 11a of the pressure sensor 11 and the bottom face 21b3 of the accommodation part 21b are welded together, the annular seal area SA can be formed on the outer circumferential side of the contact area CA where the pressure sensor 11 and the bottom face 21b3 of the accommodation part 21b are in contact with each other. Further, the tapping screw 12b has been fastened into the inner circumferential face 21b1 of the resin accommodation part 21b, and no backlash is present in a portion where the tapping screw 12b and the inner circumferential face 21b1 are fastened to each other. Thus, even when an event of an instantaneous rise in the pressure of a liquid inside the flow path 21a occurs, the state where the diaphragm 11a is pressed against the seal area SA is maintained.

The welded part 16 forms the seal area SA over the entire circumference in the circumferential direction about the axis X, and when an event of an instantaneous rise in the liquid pressure inside the flow path 21a occurs in a state where the diaphragm 11a is not pressed against the seal area SA, a part of the seal area SA may be destroyed, or the protective film 11d near the seal area SA may be broken. In the present embodiment, since the state where the diaphragm 11a is pressed against the seal area SA is maintained by the tapping screw 12b, it is possible to suitably prevent a part of the seal area SA from being damaged causing inflow of the liquid into the contact area CA.

### Other Embodiments

Although the sensor holder 12 is a member made of a metal (for example, stainless such as SUS304) in the above description, other forms may be employed. For example, the sensor holder 12 may be formed of a resin material having higher hardness than the inner circumferential face 21b1 of the accommodation part 21b of the flow path body 21 (for example, polyetheretherketone (PEEK)).

Although the pressure sensor 11 is accommodated in the accommodation part 21b in the above description, other forms may be employed. For example, other sensors configured to detect characteristics of a fluid, such as a temperature sensor may be accommodated.

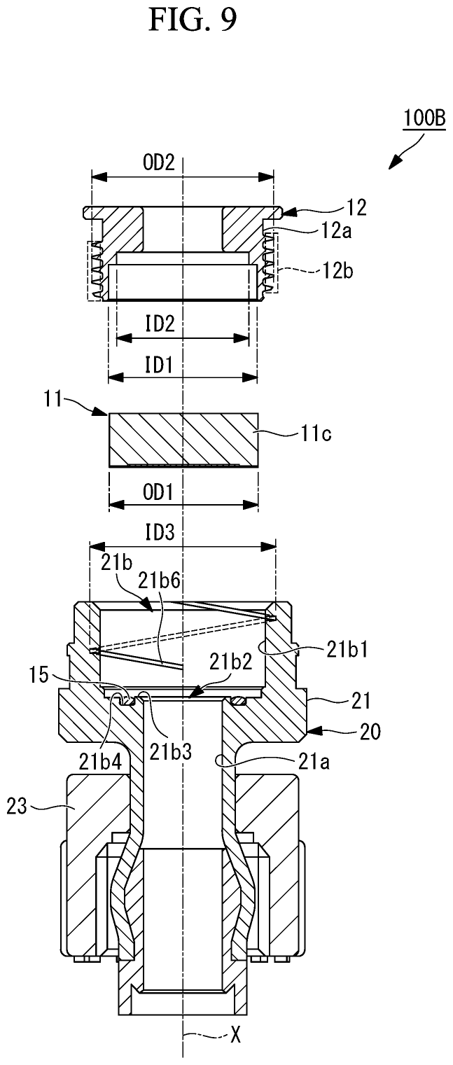

Although the two grooves 21b5 are formed spaced apart from each other in the direction along the axis X in the inner circumferential face 21b1 of the accommodation part 21b in the above description, other forms may be employed. For example, as illustrated in a pressure detection device 100B of a modified example in FIG. 9, a spiral groove 21b6 turning about the axis X may be formed in the inner circumferential face 21b1 of the accommodation part 21b. The groove 21b6 illustrated in FIG. 9 is formed in a spiral shape turning by one turn (360 degrees) about the axis X in the inner circumferential face 21b1 of the accommodation part 21b. The direction in which the spiral groove 21b6 turns may be any of the clockwise direction (right-handed) or the counterclockwise direction (left-handed). Further, the groove 21b6 may turn by one or more turns about the axis X.

According to the pressure detection device 100B illustrated in FIG. 9, since the spiral groove 21b6 is located at all positions in the direction along the axis X, deformation of the accommodation part 21b that would occur when the tapping screw 12b is fastened can be distributed evenly at respective positions along the axis X compared to a case where the grooves 21b5 are located at only the predetermined positions (two points in FIG. 8) in the direction along the axis X as with the pressure detection device 100A illustrated in FIG. 8.

Further, according to the pressure detection device 100B illustrated in FIG. 9, the groove 21b6 has a spiral shape. Thus, when the flow path body 21 is molded by injecting a resin material into a mold including the shape of the groove 21b6, it is possible to rotate and easily pull the flow path body 21 from the mold.

Further, by matching the direction in which the spiral groove 21b6 turns about the axis X and the direction the tapping screw 12b turns about the axis X, it is possible to widen the region where the tapping screw 12b and the groove 21b6 intersect each other and thereby reliably absorb deformation of the accommodation part 21b that would occur when the tapping screw 12b is fastened.

What is claimed is:

1. A fluidic device comprising:
a liquid contact part including a contact surface to be in contact with a liquid;
a resin flow path part including a flow path and an accommodation part, the flow path extending along an axis and being configured to guide a liquid to the contact surface, and the accommodation part accommodating the liquid contact part;
a fixing part configured to press the liquid contact part against the accommodation part along the axis to fix a position along the axis of the liquid contact part; and
a seal part forming an annular seal area configured to prevent inflow of a liquid to an outer circumferential side of a contact area where the liquid contact part and the accommodation part are in contact with each other,
wherein the accommodation part has
an inner circumferential face formed cylindrically about the axis,
an opening hole communicating with the flow path, and
a bottom face formed annularly about the axis so as to surround the opening hole, the liquid contact part being in contact with the bottom face,
wherein the fixing part has
an outer circumferential face formed cylindrically about the axis, and
a tapping screw formed on the outer circumferential face, and
wherein the fixing part fastens the tapping screw into the inner circumferential face to fix the liquid contact part to the accommodation part.

2. The fluidic device according to claim 1, wherein at least one groove formed annularly about the axis is formed in a region of the inner circumferential face of the accommodation part, the tapping screw being fastened to the region.

3. The fluidic device according to claim 2, wherein the inner diameter of the groove is larger than the nominal diameter of the tapping screw.

4. The fluidic device according to claim 3, wherein in the inner circumferential face of the accommodation part, a plurality of grooves are formed spaced apart from each other in a direction along the axis.

5. The fluidic device according to claim 4, wherein the distance between a pair of the grooves adjacent to each other in a direction along the axis is longer than the pitch of the tapping screw.

6. The fluidic device according to claim 1,
wherein an annular groove formed annularly about the axis is formed in the bottom face of the accommodation part,
wherein the seal part is formed annularly of an elastic material and secured in the annular groove, and
wherein the seal area is formed by contact of the seal part with the liquid contact part.

7. The fluidic device according to claim 1,
wherein the liquid contact part has
a pressure detection surface configured to detect a pressure of a liquid, and
a protective film arranged in contact with the pressure detection surface and configured to block contact between the pressure detection surface and a liquid,
wherein the protective film and the bottom face are formed of a resin material, and
wherein the protective film is arranged so as to close the opening hole of the accommodation part and welded to the bottom face in the seal area extending in a circumferential direction about the axis.

8. The fluidic device according to claim 1, wherein the fixing part is formed of a metal material.

9. The fluidic device according to claim 1, wherein the fixing part is formed of a resin material having higher hardness than the inner circumferential face of the accommodation part.

10. The fluidic device according to claim 1, wherein the liquid contact part detects a pressure of a fluid in contact with the contact surface.

11. A manufacturing method of a fluidic device,
wherein the fluidic device comprises
a liquid contact part including a contact surface to be in contact with a liquid,
a resin flow path part including a flow path and an accommodation part, the flow path extending along an axis and being configured to guide a liquid to the contact surface, and the accommodation part accommodating the liquid contact part,
a fixing part configured to press the liquid contact part against the accommodation part along the axis to fix a position along the axis of the liquid contact part, and
a seal part forming an annular seal area configured to prevent inflow of a liquid to an outer circumferential side of a contact area where the liquid contact part and the accommodation part are in contact with each other,
wherein the accommodation part has
an inner circumferential face formed cylindrically about the axis,
an opening hole communicating with the flow path, and
a bottom face formed annularly about the axis so as to surround the opening hole, the liquid contact part being in contact with the bottom face, and
wherein the fixing part has
an outer circumferential face formed cylindrically about the axis, and
a tapping screw formed on the outer circumferential face,
the manufacturing method comprising:
an installation step of installing the liquid contact part in the accommodation part; and
a fixing step of fixing the liquid contact part to the accommodation part by fastening the tapping screw into the inner circumferential face.
